(19) United States
(12) Patent Application Publication
(10) Pub. No.: US 2010/0211202 A1
(43) Pub. Date: Aug. 19, 2010

(54) METHOD AND MACHINE FOR EXAMINING WAFERS

(75) Inventors: CHIEN-HUNG CHOU, SAN JOSE, CA (US); WEN-TING TAI, FREMONT, CA (US)

Correspondence Address: ROSENBERG, KLEIN & LEE, 3458 ELLICOTT CENTER DRIVE-SUITE 101, ELLICOTT CITY, MD, 21043, US

(73) Assignee: HERMES MICROVISION, INC., HSINCHU (TW)

(21) Appl. No.: 12/370,913

(22) Filed: Feb. 13, 2009

(51) Int. Cl. G06F 19/00

(52) U.S. Cl. 700/97; 702/83

(57) ABSTRACT

Method and machine utilizes the real-time recipe to examine a series of wafers during the fabrication of integrated circuits. Each real-time recipe essentially corresponds to a practical fabrication history of a wafer to be examined and/or the examination results of at least one examined wafer of same “lot”. Therefore, different wafers can be examined by using different recipes where each recipe corresponds to a specific condition of a wafer to be examined, even these wafers are received by a machine for examining at the same time.

### BACKGROUND OF THE INVENTION

1. Field of the Invention

The present invention relates to method and machine for examining wafers, and more particularly, to method and machine for examining wafers with real-time recipes.

2. Background of the Related Art

The fabrication of integrated circuits typically includes processing a wafer using a large number of fabrication processes to form multiple integrated circuits on the wafer. These multiple integrated circuits could be then separated into individual integrated circuits. Significantly, the more fabrication processes are processed, the more defects, or the more forerunners of defects, are existent.

As usual, the wafer is examined (such as inspected and/or reviewed) to detect the existent defects (or the existent forerunners of defects). For example, a SEM (scanning electron microscope) could be used to defect whether the fabricated metal lines have short and/or clearly non-uniform line width (which is a forerunner of the short).

As usual, the examination is focused on the “hot spots” that corresponds to some specific portions of the integrated circuits where the defects and/or the forerunners of the defects usually trends to appear. The appearance of the defects and/or the forerunners might be induced by the design of the layout, and also might be induced by the practical fabrication the wafer is processed. For example, the corner of a metal line is easier to be short or to have non-uniform line width. Also for example, the center of a wafer is easier to be over-etched owing to the distribution of gas pipelines.

In general, the examination process could be performed at various stages during the fabrication of the integrated circuits. However, to avoid the risks of founding defects too late and/or the risk of hardly confirming the sources of found defects, some examination processes usually are arranged into different stage of the whole fabrication that include numerous fabrication processes. Herein, one approach is that each wafer must be examined before it is processed by the following fabrication process, and another approach is that only some of wafers are examined and other wafers are directly processed by the following fabrication process.

In practice, the operation unit of the factory is “lot’ that includes some wafers to be fabricated by same machine(s) with same assigned fabrication parameter(s) value(s). There are many reasons. For example, to save the cost of protecting wafers when wafers are transferred among different fabricating machines, and/or to save the time required to adjust the used parameter(s) value(s) of the machine.

In practice, when a “lot” is received by an examination machine, all wafers of the “lot” are examined with an identical recipe. As shown in FIG. 1, the well-known technology comprises the following steps: as shown in block 101, receives a ‘lot”; and as shown in block 102, examine each wafer of the “lot” by an identical recipe.

Herein, the recipe is practically designed, such that the examination machine could effectively detect the possible defects (even the forerunners of defects) by focusing the examination process on the “hot spot”. Clearly, for different wafers that correspond to different layouts and/or processed by different fabrication processes, the required recipes are different. There are many well-known and on-developing technologies to prepare the required recipe. In practice, when some “lots” correspond to the same integrated circuits, the recipe for each “lot” could be optimized by the following steps: as shown in block 103, modify the identical recipe according to the examination result of the “lot”, and then as shown in block 104, examine a next “lot” by the modified recipe.

However, as the dimensions of integrated circuits is continuously decreased, the yield of the wafers is becoming more and more sensitive for the defects, even the forerunners of the defects. Therefore, this is an increasing requirement to more effectively defect the defects/forerunners with less examination cost, and especially with less modification of the conventional practice.

### SUMMARY OF THE INVENTION

A method for examining wafers is to examine each wafer in same “lot” with an individual recipe instead of an identical recipe. Herein, different wafers could be examined by different recipes. The different recipes could be corresponded to the fabrication histories of different wafers and/or the examination result of other wafer(s) of the ‘lot’. Each wafer may be properly examined with the corresponding recipe.

A method for examining wafers is to generate a recipe based on the fabrication history of a wafer which is going to be examined. The recipe is a function of at least a hotspot information of the corresponding wafer. Thus, the recipe is properly in response to the practical condition of the fabrication history for the corresponding wafer.

A method for examining wafers is to generate a recipe based on the examination result of at least one examined wafer that belongs to the same “lot”. The recipe could be viewed as a function of the practical fabrication history of these wafers of the same “lot”. Hence, the recipe is properly in response to the practical fabrication history for the corresponding “lot”.

Herein, each wafer is examined after it is processed by at least one fabrication process, and each fabrication process is performed by at least one machine. Moreover, each fabrication process is performed with at least one parameter with practical values, each machine has its characteristics, and each wafer has its individual condition before it is sent into the machine for the fabrication process. Therefore, the so-called fabrication history comprises at least one of the following: (a) at least one process that the wafer has been processed; (b) at least one practical value of at least one parameter of at least one process that the wafer has been processed; (c) at least one characteristic of a machine that the wafer has been processed; and (d) at least one condition that the wafer has before the fabrication.

Herein, the examination result of a wafer indicates the existence of the defects, even the forerunners of defects. Clearly, it reflects the results of the practical fabrication history of the wafer. Therefore, owing to all wafers of a ‘lot” is processed in sequence, it is natural that the fabrication history of a former wafer should be close to the latter wafer (except the yield of a used machine is very low.) Hence, for different wafers of same “lot”, the individual recipe of each recipe also could be generated accordingly to the examination result of the examined wafer(s).

A machine for examining wafers is equipped with an examining assembly capable of examining a wafer with a recipe corresponding to a fabrication history of the wafer. The machine also is equipped with a recipe assembly capable of providing individual recipe for each wafer. Herein, the recipe for each wafer could be prepared according to the practical fabrication history of the wafer.

A machine for examining wafers is equipped with an examining assembly capable of examining a wafer with a recipe corresponding to the examination results of some examined similar wafers. The machine also is equipped with a recipe assembly capable of providing individual recipe for each wafer. Herein, the recipe for each wafer could be prepared according to the examination results of some examined wafers belonged to the same “lot.”

These and other aspects, features and advantages of the present invention can be further understood from the accompanying drawings and description of preferred embodiments.

### BRIEF DESCRIPTION OF THE DRAWINGS

FIG. 1 is a schematic diagram illustrating a method for examining wafers in accordance with the well-known technology.

FIG. 2 is a schematic diagram illustrating a method for examining wafers in accordance with an embodiment of this invention.

FIG. 3 is schematic diagram illustrating a machine for examining wafers in accordance with an embodiment of this invention.

FIG. 4 is a schematic diagram illustrating a method for examining wafers in accordance with an embodiment of this invention.

FIG. 5 is schematic diagram illustrating a machine for examining wafers in accordance with an embodiment of this invention.

### DETAILED DESCRIPTION OF THE INVENTION

Both method and machine for examining some wafers in same “lot” during the fabrication of integrated circuits on the wafers, wherein the recipe used for examining different wafers of the same “lot” could be different.

Clearly, the main difference between the invention and the conventional technology is that the invention allows different wafers in the same “lot” to be examined by different recipes.

The recipe could be briefly viewed as a set of instructions with parameter values for carrying out an examination process, such as inspection process, and some reference materials. In other words, when a recipe is complete (i.e. a complete recipe), each parameter has a specific parameter value. Hence, the wafer could be examined according to these instructions with these specific parameter values. Moreover, the complete recipe could be a function of an incomplete recipe and a hotspot information. Herein, the incomplete recipe could be reviewed as a set of instructions with incomplete parameter values for carrying out an examination process and some reference materials. In other words, some parameters have no specific parameter value (i.e., they are blank or not chosen), and/or some parameters are blank to be filled. Moreover, the hotspot information is related to the practical condition of the wafer, such as the layout of the integrated circuit to be formed on the wafer, the distribution of detected defects, and so on. As usual, the hotspot information comprises a lot of messages relevant to, for example but not limited to, a weak point or a critical point on a wafer. Hence, by using the hotspot information to assign the parameter values or choose the parameter that required by the incomplete recipe, it is natural that a complete recipe is acquired and then the examination has a specific aim.

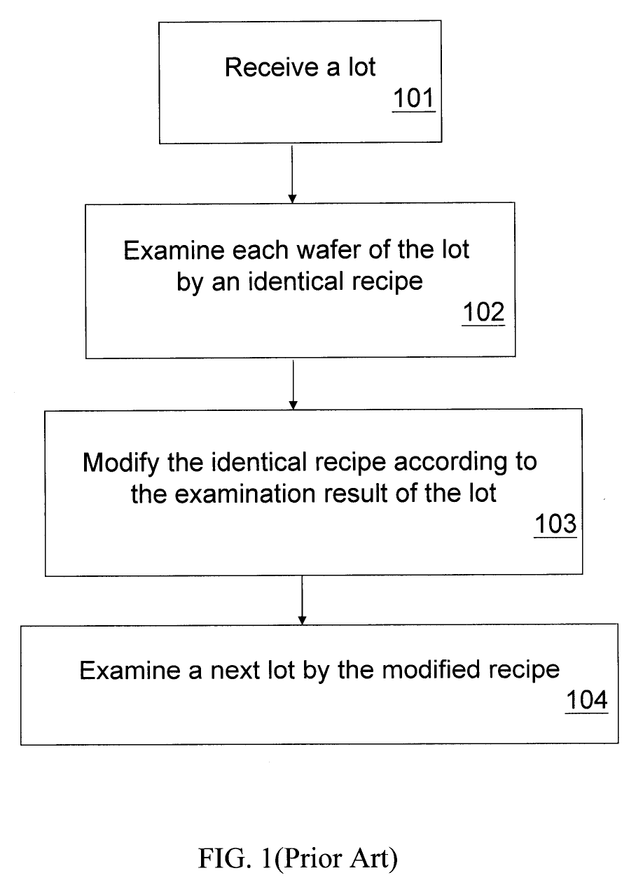

In conventional technology, as briefly discussed in FIG. 1 and related paragraphs, after all wafers of a “lot” are examined, a corresponding hotspot information could be acquired by the examination result of the ‘lot”. Then, the hotspot information could be used to product a new complete recipe for the examination of the next ‘lot”. For example, the hotspot information may indicate a specific portion of the examined wafer where the defects and the forerunners are particularly distributed over, and then the parameter vales(s) of the incomplete recipe could be assigned accordingly. After that, a complete recipe based on the distribution of defects/forerunners could be used by the examination machine to particularly examine the specific portion of other wafers in the next “lot’.

In the conventional technology, the used recipe is amended only after a “lot” has been examined. However, if the recipe does not perfectly fit the requirement of the examination of the on-going “lot”, especially if some forerunners of defects are appeared during the examination of the on-going “lot”, the conventional technology can not effectively examine each wafer of the “lot” because it can not adjust the recipe to more perfectly fit the requirement and/or to catch the variation indicated by the forerunners immediately. The conventional technology only can adjust and/or catch after a “lot” has been examined, which means at least one wafer of the “lot” is not properly enough examined.

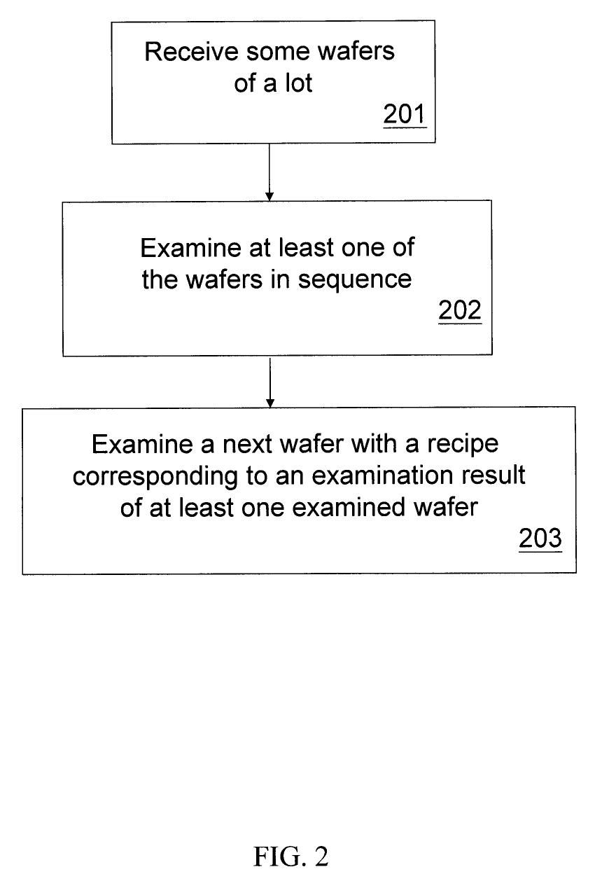

One embodiment of the invention is a method for examining wafers during the fabrication of integrated circuits. As shown in FIG. 2, the embodiment has at least the following steps: as shown in block 201, receive some wafers of a “lot”; as shown in block 202, examine at least one of the wafers in sequence; and as shown in block 203, examine a next wafer with a recipe corresponding to an examination result of at least one examined wafer(s). Significantly, the main characteristic is the block 203, wherein a wafer of the ‘lot” could be examined by a recipe corresponds to an examination result of at least one examined wafer of the “lot”, but not examined by an original recipe which is at least used to examine the first wafer. In other words, as an example, if there are only fifteen defects on an examined wafer but ten of them are focused on the left-bottom portion of the examined wafer. Then, the corresponding hotspot information will indicate more coordinates on the left-bottom portion of the wafer, such that an amended complete recipe focuses on these coordinates on the let-bottom portion of the wafer. After that, when a next wafer is examined with the amended recipe but not the original recipe, the examination of the next wafer could be focused on the left-bottom portion of the next wafer, where the defects trends to appear.

Of course, the embodiment need not and does not limit how to product new recipe according to the examination result of previously examined wafers. For example, as an example, each wafer could be examined with a specific recipe corresponding to a specific examination result of only the last examined wafer. For example, as an example, each wafer could be examined by the original recipe if the average examination result of all examined wafers does not display a specific distribution of detected defects. For example, as an example, each wafer could be examined by a specific recipe which focuses the examination on a specific portion of examined wafer if the average examination result of all examined wafers does display a specific distribution of detected defects.

It should be emphasized that the main differences between the embodiment and the conventional technology are the timing of adjusting recipe and which examination result of which wafer(s) is used to adjust recipe. How to adjust the recipe according to the examination result of the wafers is not the characteristic of the embodiment. Indeed, any known or on-developing skills could be used by FIG. 1 also could be used by the embodiment. In short, the embodiment could be easily achieved.

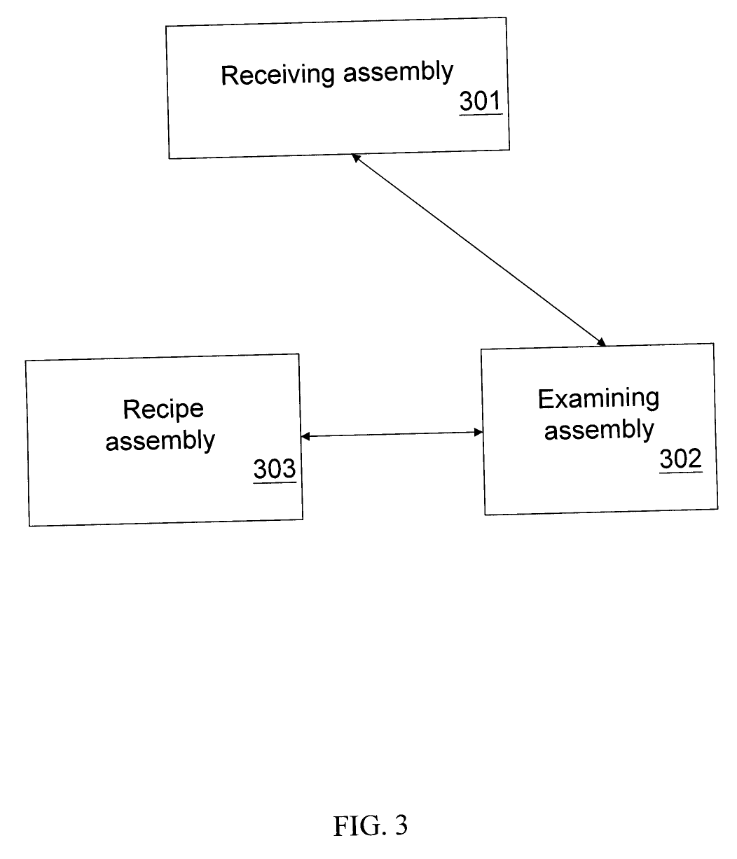

Another embodiment of the invention is a machine for examining wafers during the fabrication of integrated circuits. As shown in FIG. 3, the machine at least has a receiving assembly 301, which is capable of receiving wafer(s) of a lot; an examining assembly 302, which is capable of examining each received wafer with an individual recipe; and a recipe assembly 303, which is capable of providing each individual recipe for each corresponding wafer. Herein, the recipe assembly 303 could generate each individual recipe by itself or receiving each individual recipe from an external computer (such as the main center computer used by the factory to control some machines for fabricating integrated circuits.) Herein, each individual recipe could be generated according to the examination result of at least one examined wafer of the “lot”. For example, but not limited to, the recipe assembly 303 could provide a specific individual recipe by a specific examination result of the last examined wafer.

Moreover, as discussed above, both how to generate recipe by examination result and how to examine a wafer by a corresponding wafer is well-known. Indeed, except a circuit/algorithm is required by recipe assembly 303 to decide when to generate a new recipe (i.e., which wafer should be examined by a new recipe), the embodiment could be easily achieved by conventional technology. However, such circuit/algorithm also could be easily achieved, because such function also is well-known in other technology fields which require a decision mechanism to decide how to process target(s).

The hotspot information is not limited to only the examination result of wafer. Indeed, any message related to the defect and/or the forerunner of the defect could be hotspot information. For example, the layout could be a portion of hotspot information, because it discloses which portion (such as corner of line) of the layout is easily to have defect. For example, the examination result could be a portion of hotspot information, because it discloses where detected defects/forerunners are particularly located. Without doubt, the item “forerunner” has a broad concept, any non-ideal structure formed on the examined wafer could be the forerunner of defect. For example but not limited to, a deposited film with non-uniform height, and/or chips on same wafer with different doping dose.

Any non-ideal structures could be a potential source of defect during the following fabrication process, especially when the difference(s) between the non-ideal structure and an ideal structure is larger than a predetermined allowable range. Herein, a main source of the non-ideal structure is the difference between the practical fabrication process with practical parameter values and the ideal fabrication process with ideal parameter values. For example, even a required ideal deposited layer should have a uniform height, the practically deposited firm may have different heights on different portions of the wafer if the operation of the deposition chamber is not perfect. And then, if the following etching process could almost uniformly remove the deposited film, either some deposited film will not be removed and be left on the wafer, or some portion of the wafer will be over-etched. In fact, all practical machine is not perfect, especially when a machine has been used for a long period and is not just be maintained. Therefore, if the practical operation could be handled (the operator of the machine should understand the characteristic of the machine) or be measured (a measure device could be used for real-time monitoring), it is advantageous that the practical fabrication history is a portion of the recipe used to examine wafer.

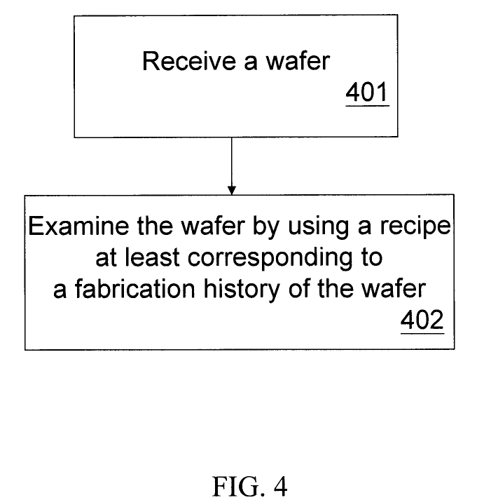

Accordingly, another embodiment of the invention is a method for examining wafers during the fabrication of integrated circuits. As shown in FIG. 4, the method has at least the following steps: as shown in block 401, receive a wafer; and as shown in block 402, examine the wafer by using a recipe that at least corresponds to a fabrication history of the wafer.

As discussed above, the fabrication history is used to handle the difference(s) between the ideal fabrication and the practical fabrication. Hence, it could be any item which is useful to indicate the difference(s). In short, the fabrication history could be at least one of the following items: (a) at least one process that the wafer has been processed; (b) at least one practical value of at least one parameter of at least one process that the wafer has been processed; (c) at least one characteristic of a machine that the wafer has been processed; and (d) at least one condition that the wafer has before the fabrication.

Herein, item (a) corresponds to what process(s) has been processed; item (b) corresponds to the practical parameter value(s) has been processed, such as the practical voltage applied into a chamber; item (c) corresponds to the practical characteristic of the used machine, such as whether an used etching machine trends to etch more on a portion of a wafer; and item (d) corresponds to the physical/chemical characteristics of a wafer, such as the temperature of the wafer before the wafer is fabricated (etched, deposited, . . . ).

The method could be applied to any machine capable of examining wafer. For example, an inspection machine, or a machine equipped with a charged particle beam to inspect wafer.

The method does not limit how to acquire recipe according to the fabrication history of the wafer. The recipe could be optionally generated according to a built-in incomplete recipe and a hotspot information provided by a factory host factory, wherein the hotspot information corresponds to the practical fabrication history of the wafer. The recipe also could be optionally received from a factory host computer that generates the recipe according to a built-in in-complete recipe and a hotspot information corresponding to the practical fabrication history of the wafer.

The recipe comprises at least one instruction having at least one parameter has been assigned with a specific value. Hence, the machine could examine the wafer according to the instruction(s) with specific parameter value(s). For example, according to an instruction which asks a charged particle beam to be projected on some specific chips (with some specific coordinates) on the wafer.

The recipe could be a function of an incomplete recipe and a hotspot information. Herein, the incomplete recipe comprises at least one specific parameter without any assigned specific value and the hotspot information could be used to assign said specific value. For example, the incomplete recipe could be an instruction which asks a charged particle beam to be projected on the some positions to be assigned, and the hotspot information could be practical polishing force distribution of a CMP (chemical mechanical polish) machine. Hence, according to the polishing force distribution, which portion of a wafer trends to be over-polished could be handled and then these positions could be particularly assigned on an over-polished region for effectively detecting whether a defect and/or a forerunner of defect is appeared.

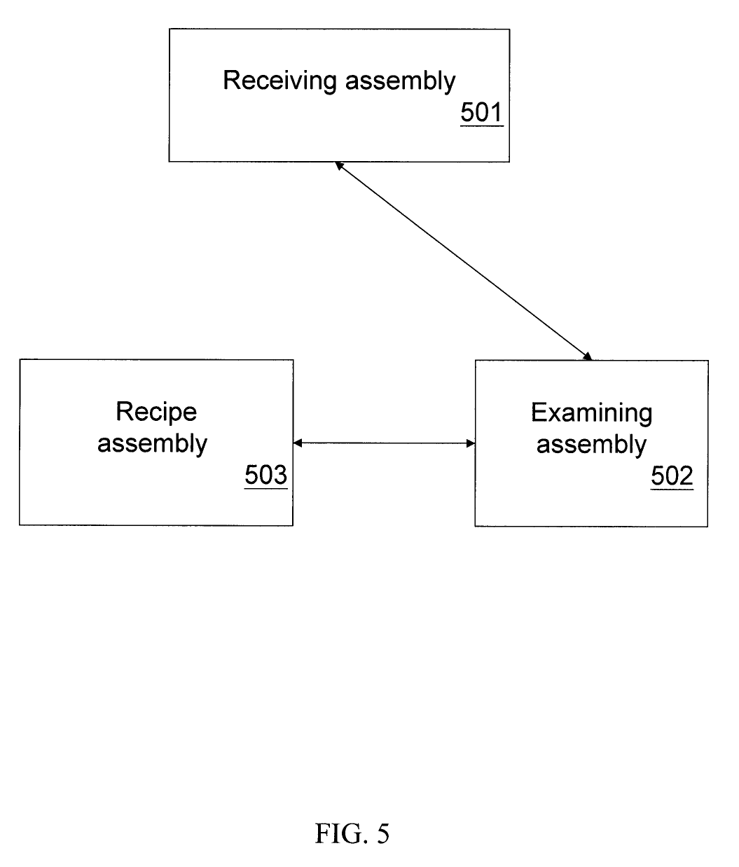

Still another embodiment of the invention is a machine for examining wafers during the fabrication of integrated circuits. As shown in FIG.5, the machine at least has a receiving assembly 501 capable of receiving a wafer and an examining assembly 502 capable of examining the wafer by using a recipe that at least corresponds to a fabrication history of the wafer. Of course, a recipe assembly 503 is used to provide the recipe to the examining assembly 502, no matter generate the recipe by itself or receive the recipe from outside.

Herein, as discussed above, the fabrication history comprises at least one of the following: (a) at least one process that the wafer has been processed; (b) at least one practical value of at least one parameter of at least one process that the wafer has been processed; (c) at least one characteristic of a machine that the wafer has been processed; and (d) at least one condition that the wafer has before the fabrication.

The recipe assembly 503 could be optionally capable of generating the recipe according to a built-in incomplete recipe and a hotspot information provided by a factory host factory, wherein the hotspot information corresponds to the fabrication history. The recipe assembly 503 could be optionally capable of receiving the recipe from a factory host computer that generates the recipe according to a built-in in-complete recipe and hotspot information corresponding to the fabrication history.

Herein, as discussed in the previous embodiments, the hotspot information is acquired or generated during the fabrication of integrated circuits and then corresponds to the practical fabrication history of the examined wafer. Thus, the examined wafer is examined with the corresponding recipe on consideration of the practical situation that the examined wafer is performed. Such messages corresponding to the fabrication history of the wafer may be included in the recipe and provide the examination system with more relevant information to the examined wafer. Thus, the examination results on the examined wafer may be more accurate compared to a conventional incomplete recipe.

The details of the complete recipe, incomplete recipe and hotspot information are not characteristics. In one example, a complete recipe may include all required messages, for example but not limited to, wafer swathing information, wafer map and die definition, wafer alignment definition, inspection system model number, optical mode(s) to be used for inspection, inspection test definition and pixel size, etc. In one example, the hotspot information may include, for example but not limited to, attributes of the design data and information about hot spots (e.g., information from a hot spot database, a source of hot spots, the locations of the hot spots in the design), the enhancing capture of known systematic defects (e.g., enhancing sensitivity for hot spots or hot spot regions), etc. In one example, for example but not limited to, the generation of hot spots may be performed by correlating multiple sources of input from design, modeling results, inspection results, metrology results, and test and failure analysis (FA) results, and fabrication history of a wafer. Moreover, the fabrication history means the practical fabrication processes and the practical parameters. As an example, a wafer is processed by a lot of procedures, for example but not limited to, film deposition, lithography technology, etching, implantation, oxidation or thermal processing, and chemical mechanical polishing. The parameters, for example but not limited to, polish pressure, period, moving speed of pad, slurry dose, and so on.

Although the present invention has been explained in relation to its preferred embodiment, it is to be understood that other modifications and variation can be made without departing the spirit and scope of the invention as hereafter claimed.

What is claimed is:

1. A method for examining wafers, comprising:
receiving a wafer; and
examining said wafer by using a recipe that at least corresponds to a fabrication history of said wafer.

2. The method as claimed in claim 1, wherein said fabrication history comprises at least one of the following:
at least one process that said wafer has been processed;
at least one practical value of at least one parameter of at least one process that said wafer has been processed;
at least one characteristic of a machine that said wafer has been processed; and
at least one condition that said wafer has before the fabrication.

3. The method as claimed in claim 1, wherein said recipe comprises at least one instruction that has at least one parameter having been assigned with a specific value, wherein said recipe could be a function of a incomplete recipe and a hotspot information.

4. The method as claimed in claim 3, wherein said incomplete recipe comprises at least one specific parameter without any assigned specific value and said hotspot information could be used to assign said specific value.

5. The method as claimed in claim 3, wherein said hotspot information indicates a specific portion of the wafer where the defects and the forerunners of the defects are particularly distributed over.

6. The method as claimed in claim 3, further comprising generating said recipe according to a built-in incomplete recipe and a hotspot information provided by a factory host factory, wherein said hotspot information corresponds to said fabrication history.

7. The method as claimed in clam 3, further comprising receiving said recipe from a factory host computer that generates said recipe according to a built-in in-complete recipe and a hotspot information corresponding to said fabrication history.

8. The method as claimed in claim 1, wherein said method is performed by a machine chosen from a ground consisting of the following: an inspection machine, and a machine equipped with a charged particle beam to inspect said wafer.

9. A machine for examining wafers, comprising:
a receiving assembly capable of receiving a wafer; and
an examining assembly capable of examining said wafer by using a recipe that at least corresponds to a fabrication history of said wafer.

10. The machine as claimed in claim 9, wherein said fabrication history comprises at least one of the following:
at least one process that said wafer has been processed;
at least one practical value of at least one parameter of at least one process that said wafer has been processed;
at least one characteristic of a machine that said wafer has been processed; and
at least one condition that said wafer has before the fabrication.

11. The machine as claimed in claim 9, wherein said recipe comprises at least one instruction having at least one parameter has been assigned with a specific value, wherein said recipe could be a function of an incomplete recipe and a hotspot information.

12. The machine as claimed in claim 11, wherein said incomplete recipe comprises at least one specific parameter without any assigned specific value and said hotspot information could be used to assign said specific value.

13. The machine as claimed in claim 11, wherein said hotspot information indicates a specific portion of the wafer where the defects and the forerunners of the defects are particularly distributed over.

14. The machine as claimed in claim 11, further comprising a recipe assembly capable of generating said recipe according to a built-in incomplete recipe and a hotspot information provided by a factory host factory, wherein said hotspot information corresponds to said fabrication history.

15. The machine as claimed in claim 11, further comprising a recipe assembly capable of receiving said recipe from a factory host computer that generates said recipe according to a built-in in-complete recipe and a hotspot information corresponding to said fabrication history.

16. The machine as claimed in claim 9, wherein said machine is chosen from a ground consisting of the following: an inspection machine, and a machine equipped with a charged particle beam to inspect said wafer.

17. A method for examining wafers, comprising:
receiving a plurality of wafers of a lot;
examining at least one of said wafers in sequence; and
examining a next said wafer with a recipe corresponding to an examination result of at least one examined said wafer.

18. The method as claimed in claim 17, wherein each said wafer is examined with a specific recipe corresponding to a specific examination result of only a last examined said wafer.

19. A machine for examining wafers, comprising:
a receiving assembly capable of receiving a plurality of wafers of a lot;
an examining assembly capable of examining each said wafer with an individual recipe corresponding to an examination result of at least one examined said wafer; and
a recipe assembly capable of providing each said individual recipe.

20. The machine as claimed in claim 19, wherein said recipe assembly provides a specific said individual recipe by a specific examination result of only a last examined said wafer.
